(19) United States
(12) Patent Application Publication
(10) Pub. No.: US 2007/0013972 A1
(43) Pub. Date: Jan. 18, 2007

(54) Continuous scanning method with a multi-page preview function

(75) Inventor: Thomas Sheng, Hsinchu (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/486,024

(22) Filed: Jul. 14, 2006

(30) Foreign Application Priority Data
Jul. 15, 2005 (TW) 094124009

(51) Int. Cl. H04N 1/04

(52) U.S. Cl. 358/474; 358/486

(57) ABSTRACT

A continuous scanning method with a multi-page preview function includes the steps of scanning a first former document having a first format to obtain a first image signal; scanning a second former document having a second format different from the first format to obtain a second image signal; displaying a first image corresponding to the first image signal for a user to preview; displaying a second image corresponding to the second image signal for the user to preview; receiving a first configuration and a second configuration, which are set by the user and respectively correspond to the first and second former documents; and continuously scanning or processing a first latter document having the first format and a second latter document having the second format according to the first and second configurations, respectively.

### BACKGROUND OF THE INVENTION

1. Field of the Invention

The invention relates to a continuous scanning method, and more particularly to a continuous scanning method having a mufti-page preview function.

2. Description of the Related Art

In the applications of scanners, a continuous scanning function is often adopted. Most conventional scanners do not provide the more human-oriented functions for the continuous scan. The user has to control the beginning of each scan operation through an operation interface. Alternatively, the user has to complete the complicated settings through the easy operation interface provided by the manufacturer. For example, when a book is being scanned, the user can configure the scanner such that the scanner can perform the continuous scan, wherein the time interval between two scans depends on the return speed and the return distance of the scanning module. When the time interval is too short, the user does not have sufficient time to turn over the page to catch up with the scan for the next page such that the continuous scan fails. Because the moving speed of the scanning module is gradually increasing, the scanner in which the time interval cannot be adjusted is disadvantageous to the continuous scan.

When the book is being scanned, the settings of the odd-numbered pages and the even-numbered pages and the initial placement state of the book are very important. If the setting for the even-numbered pages is used to scan the odd-numbered pages, the subsequent scan result may be inverted, and such a condition cannot be sensed until the scan ends. Thus, the user has to rotate all images of the scanned files to obtain the desired results. The rotation operation lengthens the processing time a lot even if a high-speed processor is used to process the images. More particularly, all the scanned files cannot be used if the settings of the cropping regions for the odd-numbered and even-numbered pages are different from each other.

### SUMMARY OF THE INVENTION

It is therefore an object of the invention to provide a continuous scanning method having a multi-page preview function such that the user can set configurations for scanned results corresponding to documents with different formats after previewing the multi-page image, and the function of continuous scanning can be achieved conveniently.

To achieve the above-identified object, the invention provides a continuous scanning method. The method includes: a first scanning step of scanning a first former document having a first format to obtain a first image signal; a second scanning step of scanning a second former document having a second format, which is different from the first format, to obtain a second image signal; a first displaying step of displaying a first image corresponding to the first image signal for a user to preview; a second displaying step of displaying a second image corresponding to the second image signal for the user to preview; a step of receiving a first configuration and a second configuration, which are set by the user and correspond to the first former document and the second former document, respectively; and a step of continuously scanning or processing a first later document and a second later document respectively having the first format and the second format according to the first configuration and the second configuration.

The method may further include a step of outputting an indicating signal to indicate a user placement information of the first later document or the second later document. The indicating signal may be an audio signal or an optical signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a document set having two formats.

FIG. 2 is a schematic top view showing a scanner for performing a continuous scanning method of the invention.

FIGS. 3 to 5 show states of a book of FIG. 1 and the scanner for performing the continuous scanning method.

FIG. 6 is a flow chart showing a continuous scanning method having the multi-page preview function according to the invention.

FIG. 7 is a schematic illustration showing a document set having three formats.

FIG. 8 is a schematic illustration showing a document set having four formats.

FIG. 9 is a flow chart showing the continuous scanning method having the multi-page preview function according to the invention.

### DETAILED DESCRIPTION OF THE INVENTION

The continuous scanning method of the invention may be adapted, without limitation, to the scanning of a book. The user may also apply this method to scan a duplex document, a large-format document, or the like.

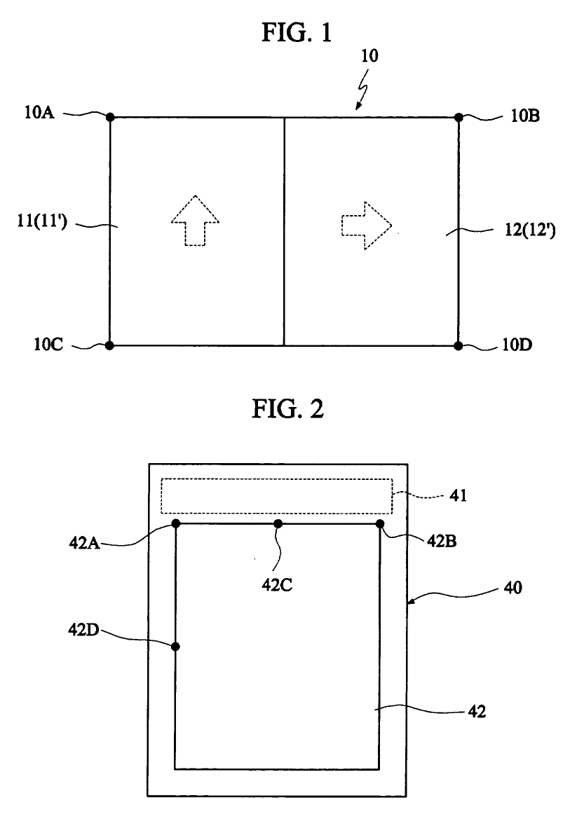

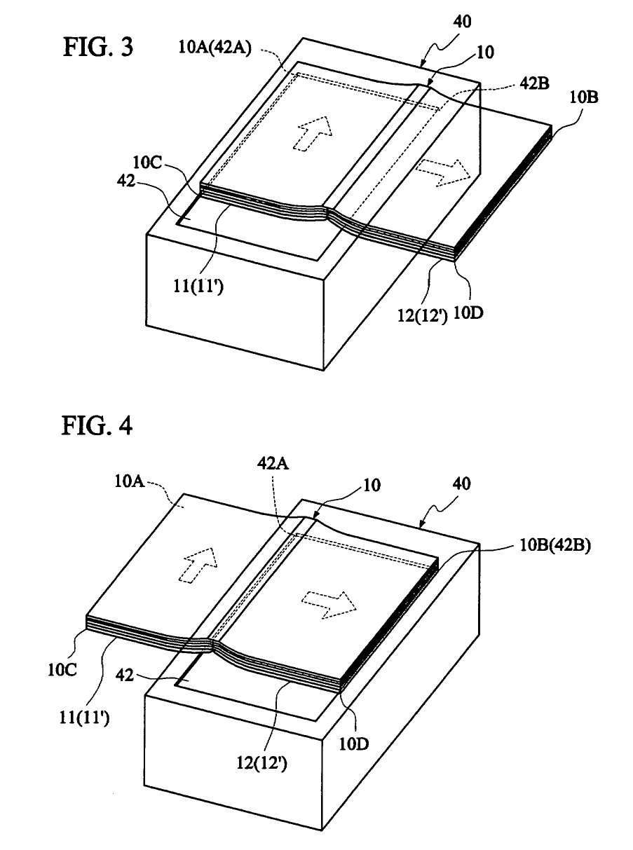

FIG. 1 is a schematic illustration showing a document set having two formats. FIG. 2 is a schematic top view showing a scanner for performing a continuous scanning method of the invention. FIGS. 3 to 5 show states of a book of FIG. 1 and the scanner for performing the continuous scanning method. Referring to FIGS. 1 to 5, a document set (e.g., a book) 10 opposite to the reader has a first former document 11 and a second former document 12. The first former document 11 and the second former document 12 respectively have a first format and a second format, which are represented by dashed-line arrows directing to different directions. The document set 10 has four positioning points (e.g., four corner points) 10A to 10D. A scanner 40 includes a scanning module 41, a transparent platen 42 for supporting the document, and four positioning points 42A to 42D.

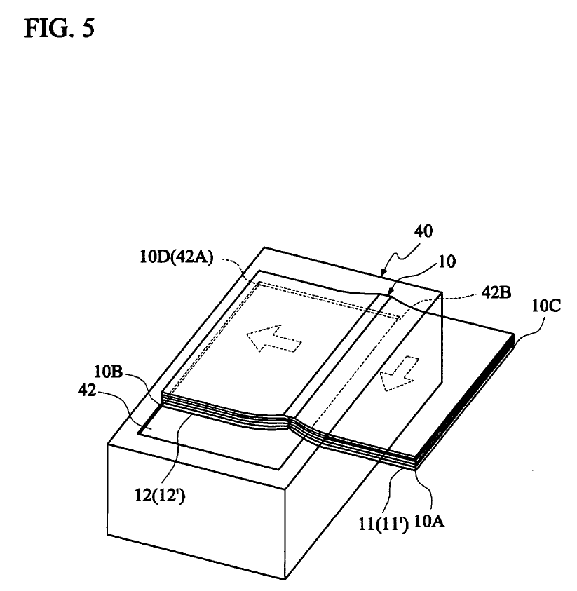

When the first former document 11 is to be scanned, the positioning point 10A of the first former document 11 is aligned with the positioning point 42A, as shown in FIG. 3, such that the scanned result is in a normal state. When the second former document 12 is to be scanned, the positioning point 10B of the second former document 12 may be aligned with the positioning point 42B, as shown in FIG. 4, such that the scanned result is also in a normal state but not an inverted state. In this case, the image scanned by the scanning module 41 does not have to be rotated because the two scanned results are in the normal states, but the cropping range, if any, may be changed. Alternatively, when the second former document 12 is to be scanned, the second former document 12 may be rotated by 180 degrees, and then the positioning point 10D is aligned with the positioning point 42A, as shown in FIG. 5. In this case, the cropping range, if any, does not have to be changed, but the image scanned by the scanning module has to be rotated by 180 degrees. Of course, there are many methods of positioning the first former document 11 and the second former document 12. Thus, many configurations corresponding to the positioning methods do exist, such that the user can make the setting according to his or her preference.

Although the above-mentioned embodiment is illustrated by taking the book in conjunction with the flatbed scanner as an example, one of ordinary skill in the art may easily understand that the invention is also suitable for the sheet-fed scanner. For example, assume the sheet-fed or the flatbed scanner is used to scan M document sets each having N documents, and the user wants to scan the N documents with a first configuration to an N-th configuration. The user can first scan the first to N-th former documents, preview the first to N-th images corresponding to the first to N-th image signals of the first to N-th former documents, and then set the first to N-th configurations corresponding to the first to N-th former documents. Next, the scanner continuously scans or processes a first later document to a N-th later document respectively having the first to N-th formats according to the first to N-th configurations. If N is equal to 4, the first configuration is to scan the first later document in a color mode, the second configuration is to scan the second later document in a black-and-white mode, the third configuration is to scan the third later document in a gray-scale mode, and the fourth configuration is to scan the fourth later document in the black-and-white mode, for example. Alternatively, the first configuration is to scan the whole range of the first later document, the second configuration is to scan an upper half portion of the second later document, the third configuration is to scan an lower half portion of the third later document, and the fourth configuration is to scan a middle portion of the fourth later document, for example. Consequently, various configurations may be set by the user according to his/her requirement, and detailed description thereof will be omitted.

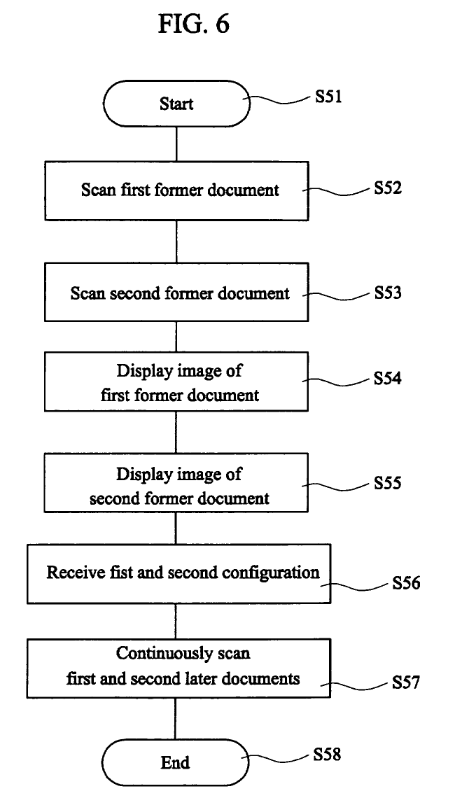

FIG. 6 is a flow chart showing a continuous scanning method having the multi-page preview function according to the invention. Referring to FIGS. 6, 2 and 1, the continuous scanning method having the multi-page preview function includes steps S51 to S58.

Step S51 starts.

Step S52 is a first scanning step of scanning the first former document 11 having the first format to obtain the first image signal.

Step S53 is a second scanning step of scanning the second former document 12, which has the second format different from the first format, to obtain the second image signal.

Step S54 is a first displaying step of displaying the first image corresponding to the first image signal for the user to preview.

Step S55 is a second displaying step of displaying the second image corresponding to the second image signal for the user to preview.

Step S56 receives the first configuration and the second configuration, which are set by the user and respectively correspond to the first former document 11 and the second former document 12. Each of the first configuration and the second configuration may include a cropping region parameter, a rotation angle parameter, an OCR (Optical Character Recognition) parameter of a specific region, a bar code identification parameter, a black-and-white or color scan mode setting parameter, a background filtering parameter, and the like. The cropping region parameter may be used to define a cropping region selected by the user, as well as the image properties, such as resolution, brightness and contrast, corresponding to this region. The rotation angle parameter may be used to determine the rotation angle of the scanned image. The OCR parameter is suitable for the document with a specific portion printed with specific characters (e.g., digits). Thus, the OCR parameter may include a region selecting parameter and a setting parameter in the text format. The setting parameter may indicate that the arrangement direction of the texts is transversal, longitudinal or transversal and longitudinal, and that the texts are Chinese characters, English characters, digit numbers or the combination thereof. The bar code identification parameter is suitable for the document having bar codes and thus includes the position of the bar code and the format of the bar code. The black-and-white or color scan mode setting parameter is suitable for the document having the black-and-white or color contents. The background filtering parameter is suitable for the document having background colors.

Step S57 continuously scans or processes the a first later document 11′ and a second later document 12′ respectively having the first format and the second format according to the first configuration and the second configuration.

Step S58 ends.

It is to be noted that the order of steps S52 to S55 may vary in addition to the above-mentioned order. For example, the first scanning step S52, the first displaying step S54, the second scanning step S53 and the second displaying step S55 may be performed in order. Alternatively, the first scanning step S52 and the second scanning step S53 may be performed in order, and the first displaying step S54 and the second displaying step S55 may be performed simultaneously such that the user can preview two images and set two configurations corresponding to the two images. Alternatively, the user may also set one time interval or two time intervals between adjacent two scans as one part of the configuration. For example, when the book is being scanned, two time intervals can be advantageously set such that the scan interval, in which the page does not have to be turned over, can be shortened, and the scan interval, in which the page has to be turned over, can be lengthened. Thus, the user can get sufficient time to turn over the page and place the document. Alternatively, a switch may be provided. In this case, after the user has placed the first later document or the second later document, he or she can trigger this switch to enable the scanning of the first later document or the second later document. This switch may be a press-button switch triggered by a force, or a voice-controlled switch triggered by voice.

It is to be noted that the continuous scanning method may further include the step of outputting an indicating signal to indicate the user the placement information of the first later document 11′ or the second later document 12′. For example, an optical signal may be provided to guide the user whether he or she has to rotate the document or the positioning point of the document has to be aligned with which point. Alternatively, an audio signal may be outputted to remind the user whether he or she has to rotate the document or where the positioning point of the document has to be located (e.g., at left, right or center).

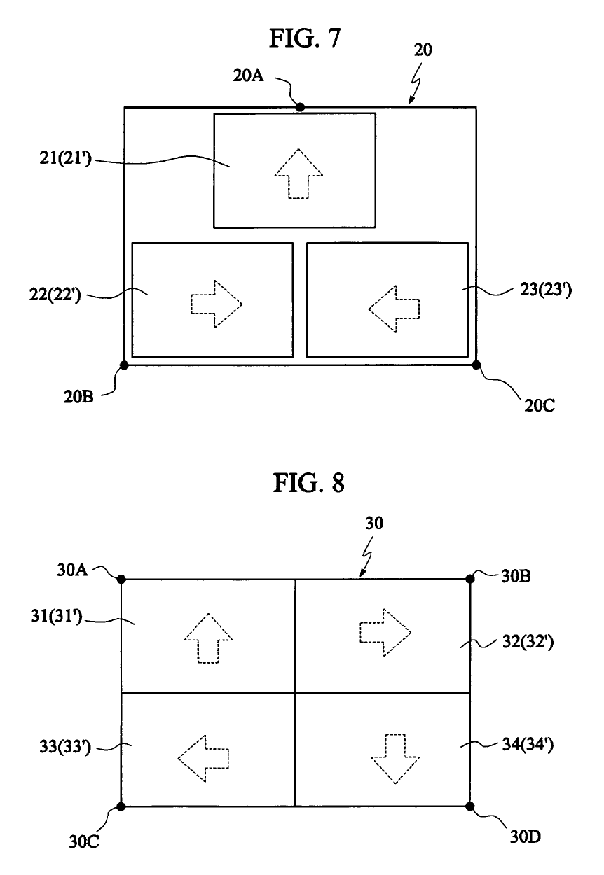

FIG. 7 is a schematic illustration showing a document set having three formats. As shown in FIGS. 7 and 2, the continuous scanning method of the invention may also be applied to the process of scanning a document set 20 having three formats. The document set 20 has a first former document 21, a second former document 22 and a third former document 23. The positioning points of the document set 20 corresponding to the scanner 40 may be positioning points 20A to 20C. When the first former document 21 is being scanned, the positioning points 20A and 42C are in alignment with each other. When the second former document 22 is being scanned, the document set 20 is rotated by 180 degrees such that the positioning points 20B and 42B are in alignment with each other. When the third former document 23 is being scanned, the document set 20 is rotated by 180 degrees such that the positioning points 20C and 42A are in alignment with each other. The alignment rules of the positioning points are not limited to those as mentioned hereinabove, and the user can make the setting according to his/her preference.

Thus, in addition to the scan preview steps of the first former document 21 and the second former document 22, the continuous scanning method of the invention may further include:

a third scanning step of scanning the third former document 23, which has a third format, to obtain a third image signal;

a third displaying step of displaying a third image corresponding to the third image signal for the user to preview;

a step of receiving a third configuration, which is set by the user and corresponds to the third former document 23; and

a step of continuously scanning or processing a first later document 21′, a second later document 22′ and a third later document 23′ respectively having the first format, the second format and the third format according to the first to third configurations. The indicating signal may also indicate the user the placement information of the third later document.

FIG. 8 is a schematic illustration showing a document set having four formats. As shown in FIGS. 8 and 2, the continuous scanning method of the invention may also be applied to the process of scanning a document set 30 having four formats. The document set 30 has a first former document 31, a second former document 32, a third former document 33 and a fourth former document 34. The positioning points of the document set 30 to be in alignment with the scanner 40 may be positioning points 30A to 30D. When the first former document 31 is being scanned, the positioning points 30A and 42A are in alignment with each other. When the second former document 32 is being scanned, the positioning points 30B and 42B are in alignment with each other. When the third former document 33 is being scanned, the document set 30 is rotated by 180 degrees such that the positioning points 30C and 42B are in alignment with each other, or the positioning points 30D and 42A are in alignment with each other. When the fourth former document 34 is being scanned, the document set 30 is rotated by 180 degrees such that the positioning points 30C and 42B are in alignment with each other, or the positioning points 30D and 42A are in alignment with each other. The alignment rules of the positioning points are not limited to those as mentioned hereinabove, and the user can make the setting according to his/her preference.

Thus, in addition to the scan preview steps of the first former document 31, the second former document 32 and the third former document 33, the continuous scanning method of the invention may further include:

a fourth scanning step of scanning the fourth former document 34, which has a fourth format, to obtain a fourth image signal;

a fourth displaying step of displaying a fourth image corresponding to the fourth image signal for the user to preview;

a step of receiving a fourth configuration, which is set by the user and corresponds to the fourth former document 34; and

a step of continuously scanning or processing a first later document 31′, a second later document 32′, a third later document 33′ and a fourth later document 34′ respectively having the first format, the second format, the third format and the fourth format according to the first to fourth configurations. The indicating signal may also indicate the user the placement information of the third or fourth later document.

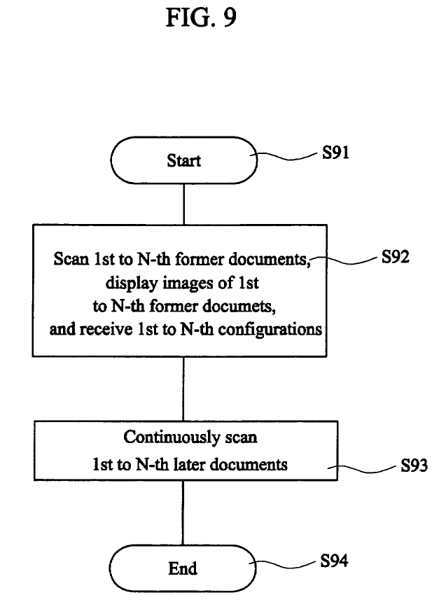

In summary, the invention may be extended to the process of scanning N kinds of later documents. FIG. 9 is a flow chart showing the continuous scanning method having the multi-page preview function according to the invention. As shown in FIG. 9, the scanning method of the invention includes the following steps.

Step S91 starts.

Step S92 scans a first former document to an N-th former document to obtain a first image signal to an N-th image signal. The first former document to the N-th former document respectively have a first format to an N-th format, wherein N is a positive integer greater than or equal to 2. Meanwhile, this step further displays a first image to a N-th image respectively corresponding to the first image signal to the N-th image signal for the user to preview, and further receives a first configuration to an N-th configuration, which are set by the user and respectively correspond to the first former document to the N-th former document. The contents of the configurations are the same as those described hereiabove, and detailed descriptions thereof will be omitted. It is to be noted that the steps of scanning the former documents, displaying the images, and receiving the configurations may be adjusted according to the requirements, and detailed descriptions thereof will be omitted.

Step S93 continuously scans or processes a first later document to an N-th later document respectively having the first format to the N-th format according to the first configuration to the N-th configuration.

Step S94 ends.

According to the continuous scanning method stated hereinabove, the user can preview the images and thus ensure that the subsequent scanning or processing and storing steps can be performed according to the configurations set by the user. In addition, providing the indicating signal to the user can guide the user to prevent the confusion due to the mass scanning. Using the continuous scanning method of the invention can scan books as well as a few documents in the scanner without an automatic document feeder. When the user sometimes wants to scan a multi-page document, he or she does not have to spend money to purchase the scanner with the automatic document feeder.

Although the above-mentioned scanner may be regarded as one connected to the computer, the scanner of the invention may also be a stand-along scanning device or a multi-function peripheral, which has a control processor and does not have to be connected to the computer. The stand-along scanning device or the multi-function peripheral may also be equipped with a display and associated operation interfaces such that the user can operate the device more conveniently.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A continuous scanning method, comprising:
a first scanning step of scanning a first former document having a first format to obtain a first image signal;
a second scanning step of scanning a second former document having a second format, which is different from the first format, to obtain a second image signal;
a first displaying step of displaying a first image corresponding to the first image signal for a user to preview;
a second displaying step of displaying a second image corresponding to the second image signal for the user to preview;
a step of receiving a first configuration and a second configuration, which are set by the user and corresponding to the first former document and the second former document, respectively; and
a step of continuously scanning or processing a first later document and a second later document respectively having the first format and the second format according to the first configuration and the second configuration.

2. The method according to claim 1, further comprising a step of:
outputting an indicating signal to indicate the user placement information of the first later document or the second later document.

3. The method according to claim 2, wherein the indicating signal is an audio signal or an optical signal.

4. The method according to claim 1, wherein the first scanning step, the first displaying step, the second scanning step and the second displaying step are performed in order.

5. The method according to claim 1, wherein the first scanning step, the second scanning step, the first displaying step and the second displaying step are performed in order.

6. The method according to claim 1, wherein the first scanning step and the second scanning step are performed in order, and then the first displaying step and the second displaying step are performed simultaneously.

7. The method according to claim 1, further comprising:
a third scanning step of scanning a third former document having a third format to obtain a third image signal;
a third displaying step of displaying a third image corresponding to the third image signal for the user to preview;
a step of receiving a third configuration, which is set by the user and corresponds to the third former document; and
a step of continuously scanning or processing the first later document, the second later document and a third later document respectively having the first format, the second format and the third format according to the first to third configurations.

8. The method according to claim 7, further comprising a step of:
outputting an indicating signal to indicate the user placement information of the first later document, the second later document or the third later document.

9. The method according to claim 8, wherein the indicating signal is an audio signal or an optical signal.

10. The method according to claim 7, further comprising:
a fourth scanning step of scanning a fourth former document having a fourth format to obtain a fourth image signal;
a fourth displaying step of displaying a fourth image corresponding to the fourth image signal for the user to preview;
a step of receiving a fourth configuration, which is set by the user and corresponds to the fourth former document; and
a step of continuously scanning or processing the first later document, the second later document, the third later document and a fourth later document respectively having the first format, the second format, the third format and the fourth format according to the first to fourth configurations.

11. The method according to claim 10, further comprising a step of:
outputting an indicating signal to indicate the user placement information of the first later document, the second later document, the third later document or the fourth later document.

12. The method according to claim 11, wherein the indicating signal is an audio signal or an optical signal.

13. The method according to claim 1, wherein the first later document or the second later document cannot be scanned until the user turns on a switch.

14. The method according to claim 1, wherein the first configuration or the second configuration comprises a cropping region parameter, a rotation angle parameter, an OCR (optical character recognition) parameter of a specific region, a bar code identification parameter, a black-and-white or color scan mode setting parameter or a background filtering parameter.

15. The method according to claim 14, wherein the cropping region parameter comprises at least one of resolution, brightness and contrast.
